(19) United States
(12) Patent Application Publication
(10) Pub. No.: US 2010/0217975 A1
(43) Pub. Date: Aug. 26, 2010

(54) METHOD AND SYSTEM FOR SECURE ONLINE TRANSACTIONS WITH MESSAGE-LEVEL VALIDATION

(76) Inventors: Garret Grajek, Aliso Viejo, CA (US); Stephen Moore, Portland, OR (US); Mark Lambiase, Ladera Ranch, CA (US)

Correspondence Address: STETINA BRUNDA GARRED & BRUCKER, 75 ENTERPRISE, SUITE 250, ALISO VIEJO, CA, 92656, US

(21) Appl. No.: 12/392,760

(22) Filed: Feb. 25, 2009

(51) Int. Cl. H04L 9/32

(52) U.S. Cl. 713/157; 713/156; 713/169

(57) ABSTRACT

A method and system for authenticating a client and a server is disclosed. In one contemplated embodiment, the client has a client certificate and the server have a server certificate. The client is validated to an authentication module based upon a certificate request identifier generated thereby, a secure data link certificate, and an authentication module Uniform Resource Locator. The authentication module is validated to the client based upon the client certificate and the certificate request identifier. A password associated with a user identifier that is encrypted with a private client key and signed with a public server key is transmitted to the authentication module. The password is then validated.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to methods and systems for authentication in secure data communications, and more particularly, to bi-directional authentication of a client and a server with a plurality of factors including an X.509 certificate.

2. Related Art

In an open network environment, the primary concern of data security is three-fold. First, the server must be assured that the client is what it asserts it is. Second, the client must be assured that the server is what it asserts it is. Third, any information being exchanged between a legitimate server and a legitimate client must not be intercepted or changed by any other computer systems on the network.

Attacks that involve a fake server made to resemble a legitimate one in order to entice a legitimate client to provide valuable information is known as a phishing attack. Much harm may be inflicted on the customer by a criminal possessing such information, including erroneous accumulation of debt, arrest records, criminal convictions, destruction of creditworthiness, damage to reputation, and so forth. These are also known as identity theft crimes.

As confidential information is being transmitted over an open network, such information must be encrypted or otherwise rendered incomprehensible to any other system besides the client and the server. The open nature of the network renders computer systems susceptible to replay attacks, where a valid data transmission is intercepted and repeated later for fraudulent or malicious purposes. For example, passwords or other authentication information may be intercepted, and used later to gain access to sensitive information. Further, the information being transmitted on the network must not be modifiable, such as in the case of man-in-the-middle attacks. This involves an attacker reading, inserting and modifying data between a legitimate client and server with neither recognizing the compromised nature of the link.

A variety of techniques is used to authenticate, or verify the identity of the client. Authentication may utilize one or more factors, which include something a user knows, something a user has, and something a user is. Most often, only a single factor is utilized because of the added cost and complexity of additional authentication factors. In such single-factor authentication systems, the most common is the use of a password or a personal identification number (PIN) to limit access. The secret nature of passwords and PINs, at least in theory, prevents unauthorized users from accessing the computer system. This technique is ineffective because the authorized users oftentimes mistakenly and unwittingly reveal their passwords or PINs to an unauthorized user. Furthermore, brute-force techniques involving the entry of every combination of letters, numbers, and symbols, as well as dictionary-based techniques, may further compromise the effectiveness of such authentication systems. Because passwords must be memorized, users often choose words that are easier to remember, making it more susceptible to defeat by means of dictionary attacks. On the other hand, the more complex the passwords are required to be, the more likely that the password will be written on something easily accessible, for both the legitimate and malicious user, in the vicinity of the computer. As asserted by the Federal Financial Institutions Examination Council (FFIEC), single factor authentication is a substantial weakness, particularly in financial or banking-related on-line services.

In addition to passwords, an additional factor may be utilized that involves something a user has. These include simple devices that are connected to the client computer through an external peripheral port, as well as sophisticated tokens that generate unique codes or one-time passwords (OTP) that are that are entered in conjunction with a username and a password as described above. Currently available token-based authentication systems include the RSA SecureID, which utilizes a time-synchronized OTP, and the Verisign Unified Authentication, which utilizes a mathematical algorithm-based OTP. While greatly increasing security, token devices are expensive to license, expensive to maintain, and cumbersome for the user to carry. As with any diminutive device, tokens are easy to lose. When lost, it may take days or weeks for a replacement, resulting in additional cost and lost productivity.

A third authentication factor is typically unique biometric attributes of a person, such as fingerprints, retinal and facial patterns, voice characteristics, and handwriting patterns. Biometric authentication, however, requires the deployment of specialized hardware for acquiring such data including fingerprint and retina scanners, microphones, and the like. Furthermore, specialized databases and software are required for comparing the acquired data to existing user data, otherwise referred to as enrollment data. Thus, the cost of such deployment is prohibitive, and is for the most part limited to large organizations. Additionally, biometric readings may be inconsistent from one acquisition to the next, resulting in false negatives. Though fingerprint identification is being increasingly used in portable computers to secure access to applications and data therein, the use of such devices to authenticate with other computer systems is uncommon because of the need to maintain an enrollment database.

To authenticate the server computer system, and to ensure that data transmissions are not intercepted, the Transport Layer Security (TLS) protocol is frequently utilized. TLS is a cryptographic protocol that provides data exchanges safe from eavesdropping, tampering, and forgery, and is often used for securing web browsing, e-mail, file transfers, and other such electronic transactions. More particularly, TLS operates on the protocol layers below application-layer protocols such as the HyperText Transfer Protocol (HTTP), File Transfer Protocol (FTP), Simple Mail Transfer Protocol (SMTP), but above the transport level protocols such as the Transmission Control Protocol (TCP) or the User Datagram Protocol (UDP). Various components of a public key infrastructure (PKI) conforming to the International Telecommunications Union—Telecommunications Standardization Sector (ITU-T) PKI standard X.509 are utilized in the TLS protocol.

Generally, public key encryption involves a unique public/private key pair held by both the recipient and the sender. The private key of the sender is retained solely by the sender, and the private key of the recipient is retained solely by the recipient. The public key of the sender is distributed and is held by the recipient, and the public key of the recipient is also distributed and held by the sender. When transmitting a message, the sender's private key and the recipient's public key is used to encrypt the message. The message is decrypted by the recipient using the recipient's private key and the sender's public key. The recipient need not have a unique public/private key pair, however, and instead may utilize a one-time cipher.

TLS is commonly implemented only on a server-side basis, however, and only the server is authenticated. For example, when establishing a secure HyperText Transfer Protocol (HTTP) connection from a client browser to a web server, the client browser retrieves a digital certificate associated with the web server. The certificate, which contains the public key, is used by the browser to authenticate the identity of the web server, and to encrypt a session key transmitted back to the web server for use in encrypting subsequent data. In order to ensure the legitimacy of the server certificate, it is signed by a Certification Authority (CA).

Though the implementation of client-side TLS establishes a bilateral trust between the server and the client and prevents identity theft and phishing attacks, there are a number of significant deficiencies. More particularly, it is necessary for the client to obtain or purchase a certificate properly signed by the CA. Thus, complications associated with certificate ownership are placed on the user. Additionally, implementing client authentication on the server is a cumbersome process, in that additional servers and maintenance is necessary. In addition to the other core functionality provided by the server, it must be configured to issue user certificates.

A number of alternatives to client-side TLS have been developed to address the aforementioned deficiencies, in particular, by the present inventors. One commercially available solution is the SecureAuth® from MultiFactor Corporation of Irvine, Calif., the assignee of the present application. Therein a solution was contemplated in which an authentication server transmits a nonce to the client web browser, and, in turn, the client initiates a TLS connection back to the server. In the course of establishing the TLS connection, the server certificate may be exchanged with the client. Thereafter, the client transmits a packet containing the nonce, a preexisting client certificate, and the received server certificate among other possible data, which are all encrypted with the server public key and signed with the client private key. The contents of the packet are verified against corresponding known versions retained by the authentication server, and absent any abnormalities, access to a network resource is permitted. The initial transfer of the client certificate from the authentication server may be way of out-of-band authentication steps taking place over voice calls, Short Message Service (SMS) messages, e-mail, and so forth. From the client certificate, the PKI public and private key pair can be generated.

This technique, while advantageous in many different respects, would likely not ensure security where the TLS termination point, e.g., the enterprise firewall, load balancer, TLS accelerator, proxy server, etc. was topographically distant from the authentication server despite being in the same inside network. For example, many large-scale network computing/server resource needs are met with the deployment of a collection of machines or clusters for high availability or load balancing purposes. In such an environment, it may be difficult to determine if any particular one of the machines is rogue and is compromising the security of the authentication server.

Accordingly, there is a need in the art for an improved method and system for encrypting inter- and intra-network data communications at the message level, as well as bi-directionally authenticating the client and the authentication server beyond the secure connection termination point.

### BRIEF SUMMARY

In accordance with one embodiment of the present invention, there is contemplated a method for authenticating a client and a server. The client may have a client certificate and the server may have a server certificate. The method may begin with validating the client to an authentication module. The validation may be based upon a certificate request identifier generated by the authentication module, a secure data link certificate, and an authentication module uniform resource locator (URL). The method may also include the step of validating the authentication module to the client. This validation, in turn, may be based upon the client certificate and the certificate request identifier. Thereafter, the method may continue with transmitting a user identifier and an associated password to the authentication module. The password may be encrypted with a private client key of the client certificate and signed with a public server key of the server certificate. The method may conclude with validating the password for the client to access the server.

According to another embodiment of the present invention, a method for bi-directionally authenticating a client and a server is contemplated. The method may begin with validating the client and an authentication module over a secure communications link. In this step, a server certificate and a certificate request identifier signed by a server private key may be received by the client. Then, the method may continue with receiving a password request, the server certificate, and the certificate request identifier that is signed with the server private key. The password request may be associated with a user identifier. The method may also include the step of transmitting a password that is responsive to the password request. The password may be encrypted with a server public key and signed with a client private key. Then, there may also be a step of receiving a server validation message upon the user identifier and the password being validated.

According to another aspect of the method, the step of validating the client and authentication module may include receiving a first request to access the server from the client. Then, there may be a step of transmitting the certificate request identifier and the server certificate to the client in response to the first request. The certificate request identifier may uniquely correspond to the first request. Furthermore, the certificate request identifier may also be signed by the server private key. The method may also include the step of establishing the secure data transfer link between the client and the authentication module. During the establishment of the secure data transfer link, a secure data link certificate and a locator address associated with the authentication module may be transmitted to the client. Thereafter, the method may continue with transmitting a credential packet to the authentication module. The credential packet may include the client certificate, the certificate request identifier, the locator address, the secure data link certificate, and an authenticity identifier of the credential packet. The credential packet may be signed with the server public key. The method may also include the step of validating the credential packet.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an exemplary network computing environment in which one aspect of the present invention may be implemented, including various interconnected servers and clients;

FIG. 2 is a flowchart illustrating a method for authenticating a client and a server in accordance with one embodiment of the present invention;

FIG. 3 is a flowchart illustrating the sub-steps of validating a client computer system and an authentication server;

FIG. 4 is a sequence diagram illustrating the exchange of data for validating the client computer system and the authentication server;

FIG. 5 is an example client and server digital certificate including various subparts thereof;

FIG. 6 is a sequence diagram illustrating the establishment of a Transport Layer Security (TLS) connection between the client computer system and the authentication server;

FIG. 7 is an exemplary response packet transmitted from the client computer system to the authentication server;

FIG. 8a-c are flowcharts illustrating the step of verifying the response packet in accordance with one embodiment of the present invention; and

FIG. 9 is a flowchart illustrating message-level validation steps.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

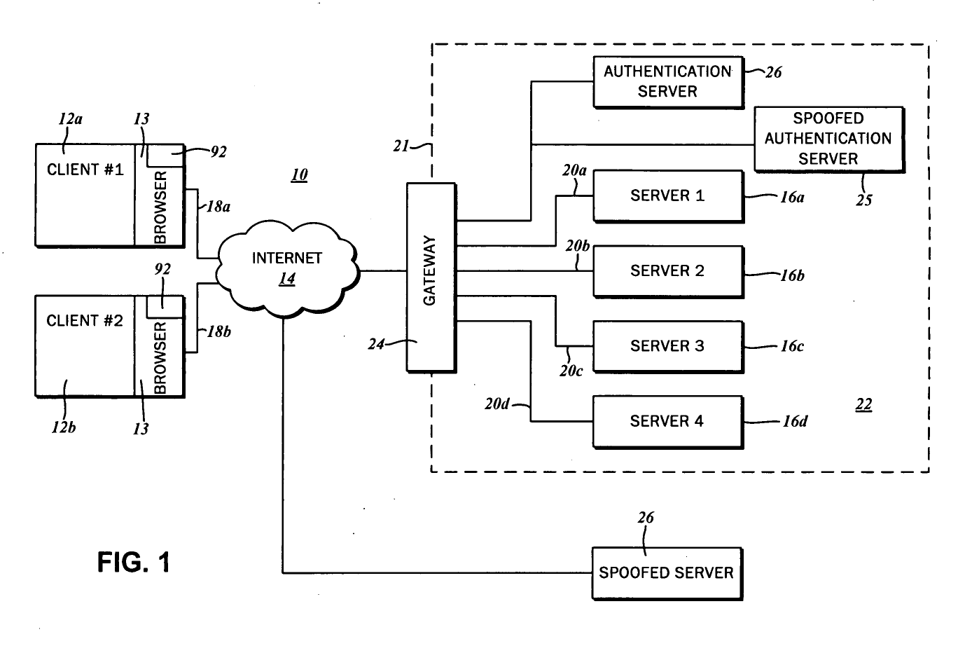

FIG. 1 illustrates an exemplary networked computing environment 10 upon which particular embodiments of the present invention may be implemented. In further detail, the networked computing environment 10 includes client computer systems 12, which are understood to be conventional personal computers having a central processing unit, memory, and input and output devices connected thereto such as keyboards, mice, and display units. Additionally, the networked computing environment 10 includes server computer systems 16 that provide data or services to the client computer systems 12. In this regard, the term “client” is understood to refer to the role of the client computer system 12 as a requester of data or services, while the term “server” is understood to refer to the role of the server computer systems 16 to provide such data or services. Of course, it is possible that the server computer systems 16 may also request data or services in one transaction and provide data or services in a transaction.

The computer systems 12, 16 are connected to a wide area network such as the Internet 14 via network connections 18, 20, respectively, which may utilize any known or future data transmission protocol. Requests from the client computer systems 12 and requested data from the server computer systems 16 are delivered through the network connections 18, 20. In the particular example shown, the server computer systems 16 are understood to be part of a local area network (LAN) or intranet 22, comprised of the network connections 20a-20d that link the server computer systems 16 to an enterprise gateway 24 that is in turn connected to the Internet 14.

The multiple server computer systems 16a-16d may be clustered, that is, linked together closely to resemble a single computer system to outside nodes such as the client computer systems 12. In this regard, all of the computer systems behind the enterprise gateway 24 will be generally referred to herein as a server system 21. Additional computer systems having different functionalities from the server computer systems 16a-16d but still within the intranet 22 will be introduced and discussed in greater detail below, though it is to be understood that references to the server system 21 are intended to encompass such additional nodes. When necessary to distinguish between the server computer systems 16a-16d and such additional nodes, the more specific references thereof will be employed. As previously indicated, clustering may be implemented for load balancing and/or high availability purposes. Although a particular network computing environment 10 having a specific topology has been illustrated, it will be appreciated by those having ordinary skill in the art that numerous variations thereof may be readily substituted without departing from the scope of the present invention.

The client computer systems 12 and the server system 21 may have software instructions loaded thereon that, when executed, perform various functions in accordance with embodiments of the present invention. By way of example only and not of limitation, the client computers 12 may have web browsing applications 13 such as Internet Explorer from Microsoft Corporation of Redmond, Wash., or Firefox from the Mozilla Foundation that communicate with remote servers to download and display various web pages. As will be described in further detail below, the web browsing applications 13 may have various secure data link features such as cryptographic certificate stores, encryption/decryption engines and the like. The server system 21 may comprise, for example, an e-commerce service in which the applications running thereon variously include web servers, databases, and the like.

Continuing with the foregoing example of the network computing environment 10, a user on a first client computer system 12a may be attempting to gain access to private data and/or services provided by the server system 21. One information security concern is for the legitimate server systems 21 to ensure that the user on the first client computer system 12a is who it is asserted to be. For example, a malicious user on a second client computer system 12b may have all of the credentials of the user on the first client computer system 12a to access the server computer systems 12 without being recognized that the access is fraudulent. Another security concern is for the legitimate user on the first client computer system 12a to be ensured that the server system 21 is indeed legitimate, and not masquerading as a spoofed server 25 configured to resemble its legitimate counterpart. Additionally, legitimate data transfers between the first client computer 12a and the server computer systems 16 must not be intercepted by any of the other computer systems in the environment 10.

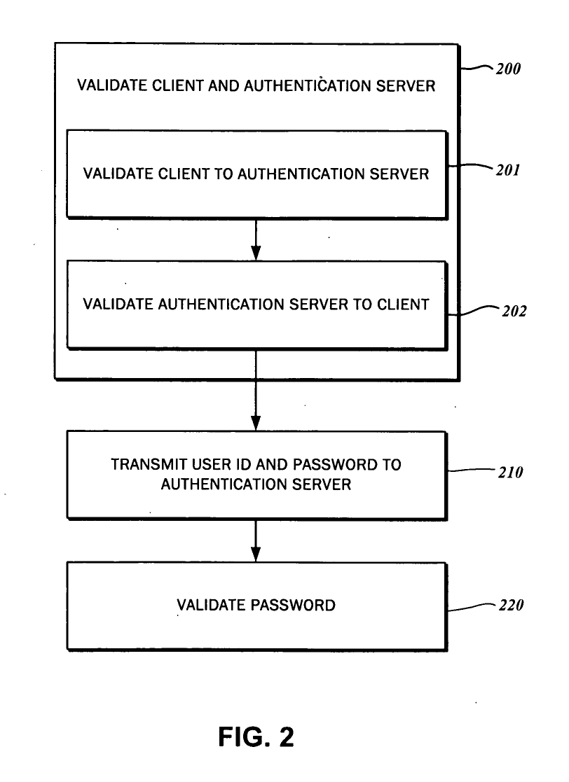

At a first level, one embodiment of the present invention contemplates a method for authenticating the client computer system 12 and the server system 21 at its endpoint: the enterprise gateway 24. To this end, the server system 21 includes an authentication module such as the standalone authentication server 26. With reference to the flowchart of FIG. 2, the method begins with a step 200 of validating the client computer system 12 and the authentication server 26 over a secure communications link, which involves a first substep 201 of validating the authentication server 26 to the client computer system 12 and a second sub step 202 of validating the client computer system 12 to the authentication server 26.

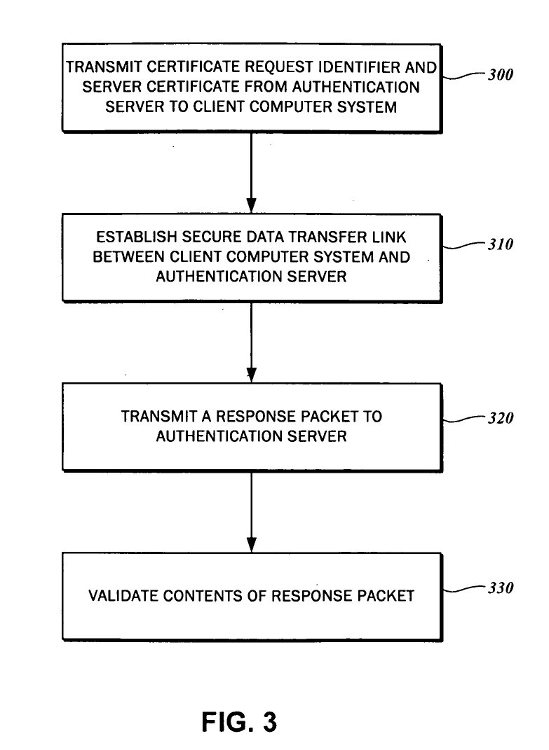

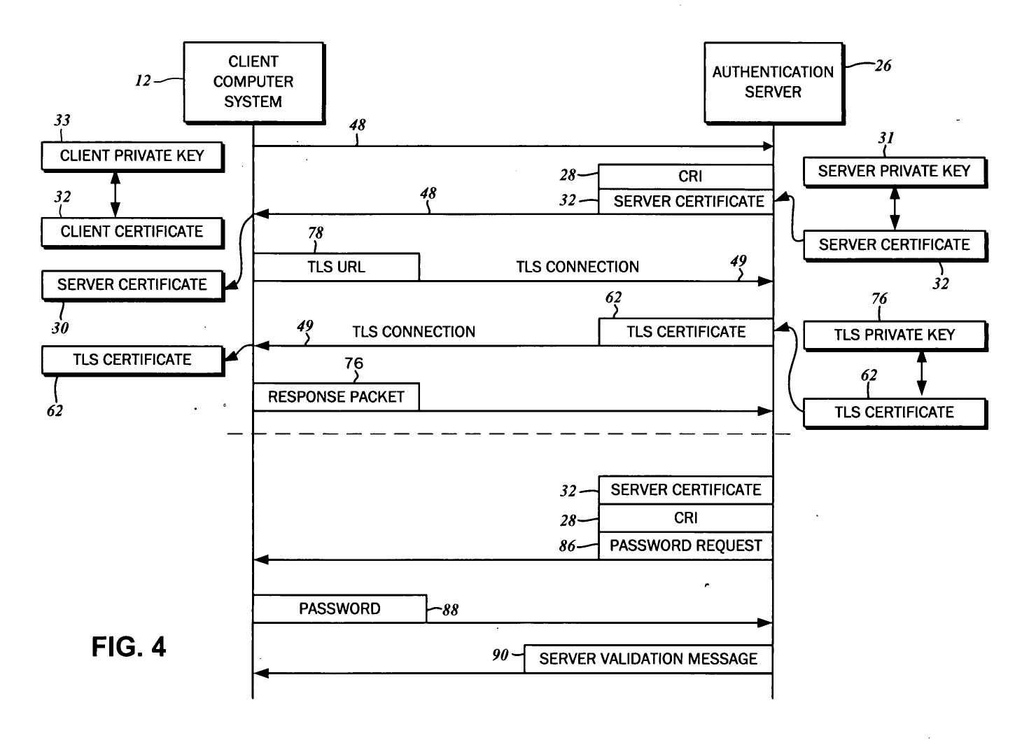

With reference to the detailed flowchart of FIG. 3 and additionally to the sequence diagram of FIG. 4, the step 200 of validating the client computer system 12 and the authentication server 26 begins with a substep 300 of transmitting a server certificate 30 and a certificate request identifier 28 that is signed by a server private key 31 and encrypted with a user's certificate public key 32. The certificate request identifier 28 is understood to contain a random value, also referred to in the art as a nonce, which identifies the particular request. As will be described in further detail below, the certificate request identifier 28 is maintained on the authentication server 26 to ensure that only the transactions referenced thereby are deemed valid. It is understood that the random value prevents replay attacks.

Before the transmission of the certificate request identifier 28 and the server certificate 30, there may be an initial step of the client computer system 12 initiating the unsecured data link 48 in an attempt to connect to one of the server computer systems 16 by way of initiating a transmission to the server system 21. In the present example, the user may input the full qualified domain name (FQDN) or web uniform resource locator (URL) of the server system 21 into the browser application of the client computer system 12, at which point a request is made for a specific file or page. At this initial step, the client computer system 12 may be redirected to the authentication server 26 to begin the aforementioned validation step 200.

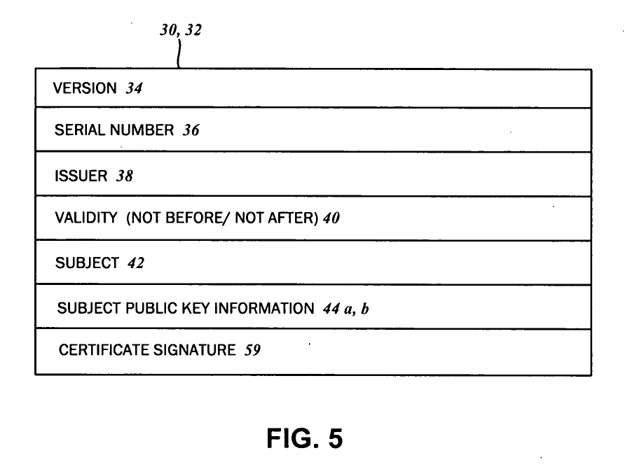

The server certificate 30 and the client certificate 32 are understood to be X.509 certificates, and cryptographically correspond to the server private key 31 and a client private key 33 that are retained solely by the authentication server 26 and the client computer system 12, respectively. As illustrated in FIG. 5, the data stored in the server certificate 30 may include, for example, a version number 34, a serial number 36, an issuer identifier 38, a validity identifier 40, a subject 42, a subject public key information 44 including a public key algorithm identifier 44a and a subject public key 44b, and a certificate signature 46. The version number 34 identifies the version of the X.509 standard being used for the particular certificate, while the serial number 36 is a unique number assigned by a particular Certificate Authority (CA). The issuer identifier 38 includes the name of the CA that issued the certificate, and a validity identifier 40 includes a validity date range with earlier and later limits. The subject identifier 42 contains the name of a person, group, or organization to which the certificate was issued. The subject public key algorithm identifier 44a denotes the algorithm used to generate the subject public key 44b, and the subject public key 44b contains the public key associated with the certificate. The certificate signature 46 contains a signature as generated by the CA.

Because the certificate request identifier 28 is encrypted with the public key in the client certificate 32, only the corresponding client private key 33 can decrypt the same. A completed decryption of the certificate request identifier 28, together with the verified signature of the server certificate 30, ensures that the authentication server 26 is legitimate, completing substep 201 of validating the authentication server 26 to the client computer system 12.

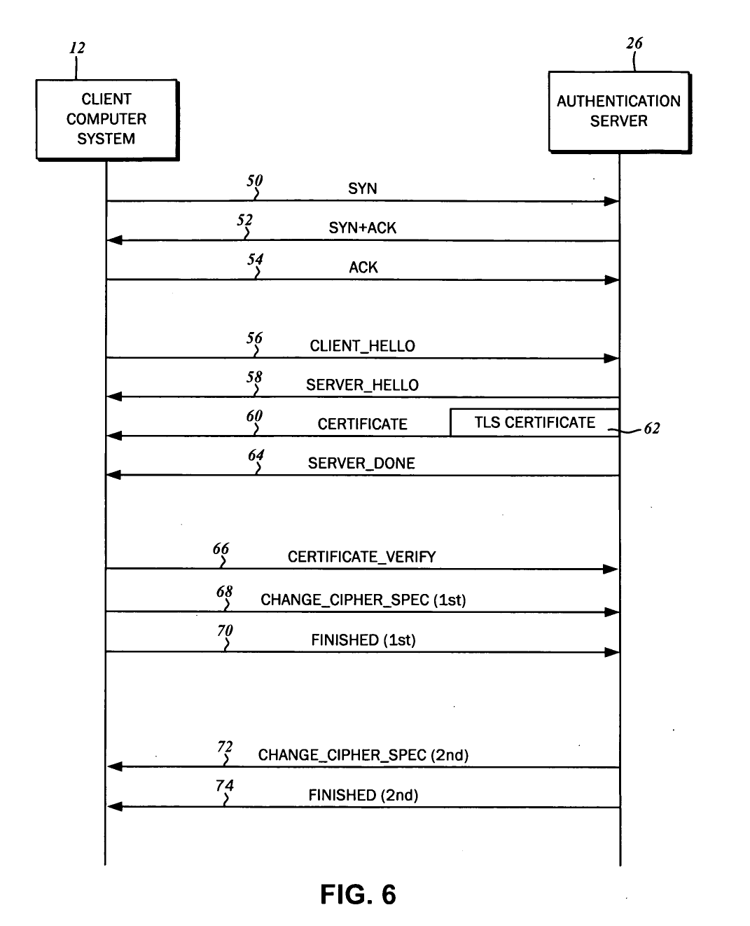

Upon receipt of the certificate request identifier 28 and the server certificate 30, the method continues with a substep 310 of initiating a secure data transfer link 49 from the client computer system 12 to the authentication server 26 or an endpoint such as the enterprise gateway 24 utilizing an authentication server Uniform Resource Locator (URL) 78. In accordance with a preferred embodiment, the secure data transfer link 49 is a symmetric TLS link. In further detail with reference to the sequence diagram of FIG. 6, the client computer system 12 initiates a connection to the authentication server 26 by transmitting a synchronize, or SYN packet 50. Thereafter, the authentication server 26 transmits a synchronize and acknowledge, or SYN+ACK packet 52 to the client computer system 12. Upon receipt, the client computer system 12 re-sends an acknowledge, or ACK packet 54 to the authentication server 26. As understood, the foregoing transmissions relate to the Transmission Control Protocol (TCP), a protocol layer underneath the TLS protocol.

Upon establishing a TCP connection between the client computer system 12 and the authentication server 26, a CLIENT_HELLO command 56 is sent from the client computer system 12 to the authentication server 26. This packet includes the highest version of TLS supported by the client computer system 12, the ciphers and data compression methods supported by the client computer system 12, a session identifier, and random data. Upon receipt of the CLIENT_HELLO command 56, the authentication server 26 transmits a SERVER_HELLO command 58. The SERVER_HELLO command 58 includes the version of TLS, cipher, and data compression method that has been selected. Additionally, the previously set session identifier is included, as well as additional random data. Thereafter, the authentication server 26 transmits the CERTIFICATE command 60, which includes a TLS certificate 62, and a SERVER_DONE command 64, which indicates that the authentication server 26 has completed this handshaking phase.

After verifying the authenticity of the TLS certificate 62, the client computer system 12 transmits a CERTIFICATE_VERIFY command 66. Additionally, the client computer 12 transmits a first CHANGE_CIPHER SPEC command 68, followed immediately by a first FINISHED command 70. This indicates that the contents of subsequent TLS record data sent by the client computer system 12 during the current session will be encrypted. It is understood that the first FINISHED command 70 includes a digest of all handshake commands previously transmitted to ensure that no alteration occurred. Next, the authentication server 26 transmits a second CHANGE_CIPHER_SPEC command 72, followed immediately by a second FINISHED command 74. Like the first CHANGE_CIPHER_SPEC command 68, the second CHANGE_CIPHER SPEC command 72 indicates that subsequent TLS record data sent by the authentication server 26 during the current session will be encrypted. The second FINISHED command 74 includes all prior handshake commands from the server computer 14 to the client computer 12. The client computer system 12 transmits a generated symmetric key that is encrypted with the subject public key 44b in the TLS certificate 62. A TLS private key 76 is used to decrypt to the symmetric key upon receipt by the authentication server 26, and subsequent transmissions to the client computer system 12 will be encrypted therewith.

As indicated above, the client computer system 12 securely retrieves the TLS certificate 62 in accordance with an aspect of the present invention. Specifically, according to the process of establishing the secure data link 49 between the client computer 12 and the authentication server 26, the server certificate 30 is transmitted. In one embodiment, the client computer 12 stores the server certificate 46 for use outside the context of the TLS connection 30, as will be detailed further below.

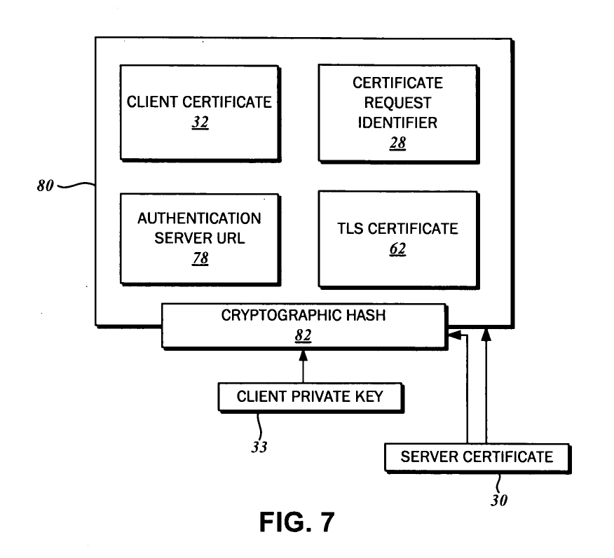

Referring again to FIG. 3, the method continues with a step 320 of transmitting a response packet 80 to the authentication server 26. In further detail shown in FIG. 7, the response packet 80 is comprised of the client certificate 32, the authentication server URL 78, the certificate request identifier 28, and the TLS certificate 62. According to one embodiment of the present invention, the Microsoft CryptoAPI libraries are utilized to retrieve the client certificate 32 from a certificate storage location. The response packet 80 includes an additional authentication identifier correlated to the client private key 33. According to one embodiment of the present invention, such authentication identifier is a cryptographic hash 82 resulting from signing the response packet 80 with the client private key 33. By way of example only and not of limitation, the Message Digest Algorithm-2 (MD2) hash function is used, though any other hash function such as Message Digest Algorithm-5 (MD5), Secure Hash Algorithm (SHA) or the like may be substituted without departing from the scope of the present invention. The response packet 80 is then encrypted with the server certificate 30.

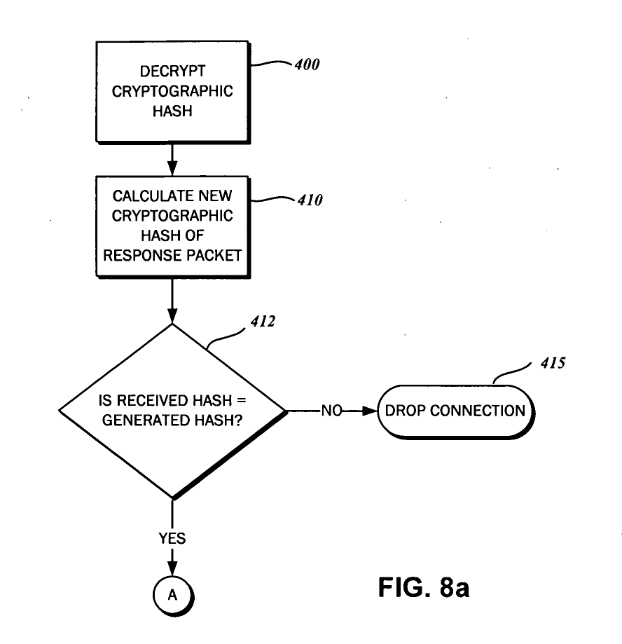

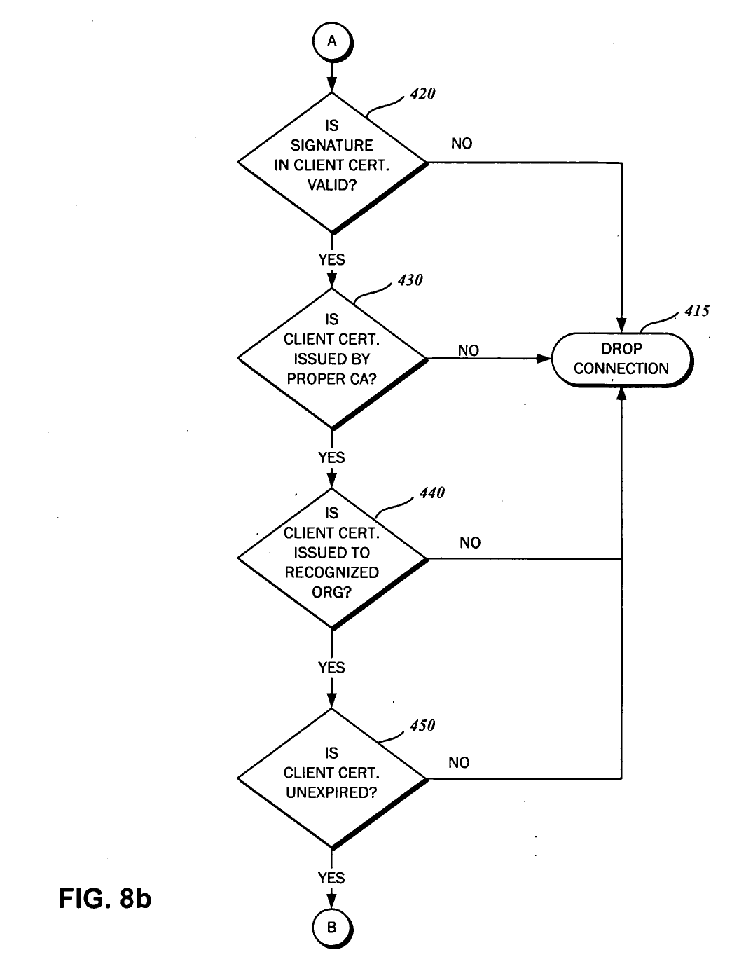

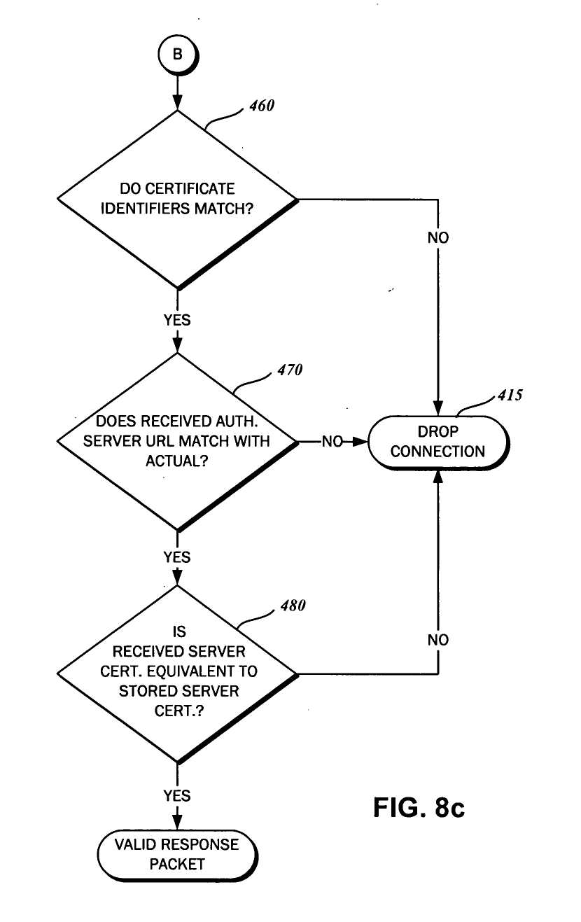

According to step 330, the method further includes validating the contents of the response packet 80. First, the authenticity of the response packet 80 itself is verified. As indicated above, the response packet 76 includes the cryptographic hash 82 that was generated as a result of signing the response packet 80 with the client private key 33. With reference to the flowchart of FIGS. 8a-8c, according to step 400, the received client-side cryptographic hash 82 is decrypted using the client certificate 32. A server-side cryptographic hash is computed for the response packet 80 as existing on the authentication server 26, and is compared against the received client-side cryptographic hash 82 accompanying the response packet 80 per comparison step 412. If the values do not match, then the response packet 80 is deemed to have been tampered with, and any connections are terminated as in step 415. If the values match, further verification of the contents of the response packet 80 continues as described below.

With additional reference to FIG. 5, such further verification includes comparing the constituent parts of the response packet 80 with known copies thereof. First, the signature of the client certificate 32 is validated per step 420, where the subject public key information 44b is verified. Thereafter, the certificate signature 46 and the issuer identifier 38 are examined to confirm that a properly recognized CA has signed the client certificate 32 per step 430. The subject identifier 42 is also examined to confirm that the client certificate 80 was issued to a properly recognized organization according to step 440. According to one embodiment, a properly recognized organization refers to a legitimate organization having control over the authentication server 26. Additionally, the client certificate 32 is confirmed to be valid and unexpired by comparing the validity identifier 40 of the client certificate 32 against the current date per step 450. If any of the foregoing validation steps fail, the client certificate 32 is deemed to be invalid, and drops the connection per step 415.

The remaining components in the response packet 80 are also verified, including the authentication server URL 78, the certificate request identifier 28, and the TLS certificate 62. As described above, the certificate request identifier 28 is stored in the authentication server 26. Per step 460, such stored value is compared against value of the certificate request identifier 28 in the response packet 80. It is understood that matching values confirms that no replay attacks are taking place. With respect to the authentication server URL 78 in step 470, the value thereof is verified against the actual URL of the authentication server 26. This is understood to verify that the credential is not being replayed, and that no phishing attacks are taking place that redirect the client computer system 12 to a malicious server. With respect to the TLS certificate 62 included in the response packet 80, per step 480, it is compared against a copy of the same residing on the authentication server 26. This detects man-in-the-middle attacks, as a different TLS certificate 62 from the one stored on the authentication server 26 as opposed to the one being returned via the response packet 80. Along these lines, if any of the foregoing verifications fails, the connection between the authentication server 26 and the client computer system 12 is immediately broken, and no further access to the authentication server 26 is permitted. As will be appreciated, the foregoing verifications discover one or more security breaches, and further, completes the step 202 of validating the client computer system 12 to the authentication server 26.

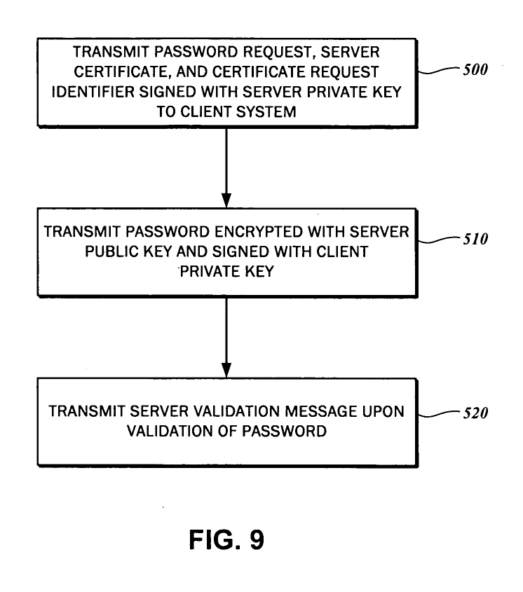

As indicated above, the first level according to one embodiment of the present invention involves authenticating the client computer system 12 and the server system 21 at its endpoint, that is, the enterprise gateway 24. The present invention additionally contemplates securing against rogue servers within the local area network or intranet 22, such as, for example, a spoofed authentication server 84. Referring now to the flowchart of FIG. 2, according to one embodiment, the method continues with a step 210 of transmitting a user identifier and a password to the authentication server 26. In further detail shown in the flowchart of FIG. 9 and the sequence diagram of FIG. 4, there is a preliminary step 500 of transmitting a password request 86, the server certificate 30, and the certificate request identifier 28 from the authentication server 26 to the client computer system 12. It is contemplated that the certificate request identifier 28 is signed by the TLS private key 76. The transmission of the password request 86 may also involve the “display” of a password prompt on the client computer system 12 to solicit input. A username corresponding to the requested password may be entered and transmitted to the authentication server 26 at an earlier time.

After receipt of the certificate request identifier 28, the signature thereon, which is intended to correspond to the server certificate 30 because it is signed with the associated server private key 31, is validated. This confirms that the request is from a legitimate authentication server. Thereafter, as further detailed in step 510, an entered password 88 that is signed with the client private key 33 and encrypted with the server certificate public key 30 is transmitted to the authentication server 26. The authentication server 26 then decrypts the password 88 with the server private key 31, and validates the signature with the client certificate 32 in its possession. It is expressly contemplated that the username and password 88 combination is not maintained by the authentication server 26, and has no knowledge of the same. Instead, it is retrieved from the enterprise data store, that is, in one of the server computer systems 16. In this sense, the step 220 of validating the password 88 refers to the verification that the client computer system is legitimately communicating with the authentication server 26. In other words, the client computer system 12 can be ensured that the password 88 is capable of being decrypted only by a legitimate authentication server, and the authentication server 26 can be ensured that the password 88 is coming from the legitimate client computer system 12. This is based upon the aforementioned steps of encrypting with the server certificate 30 and signing with the client private key 33. Essentially, the credential or password 88 is fingerprinted with the information unique to the client computer system 12. The password 88 is not valid if the fingerprinting information is removed; thus, the password is not vulnerable to conventional password-breaking techniques such as brute force attacks.

After the validation step 220, the method includes a further detailed step 512 of transmitting a server validation message 90 to the client computer system 12. This informs the client computer system 12 and its pertinent software applications that the session is valid. By way of example only and not of limitation, the server validation message may be a .NET or Java 2 Enterprise Edition (J2EE) session ticket, a Security Assertion Markup Language (SAML) response, a CA SiteMinder response, an IBM Tivoli Access Manager for E-Business (TAMeb) response or other like credential. Thereafter, the client computer system 12 continues to interact with the server system 21, and specifically, the server computer systems 16.

It will be appreciated that the aforementioned method presupposes that the client certificate 32 and its corresponding client private key 33 already exist on the client computer system 12. The authentication server 26 may determine whether or not the client certificate 32 exists on the client computer system 12, and if not, install the client certificate 32 on the client computer system 12 according to one of several contemplated methods. One embodiment contemplates transmitting issuing a token via an out-of-band modality such as a cellular phone, e-mail, or a Short Message Service (SMS) text message, among others. The token is provided to the client computer system 12, which in turn transmits the same to the authentication server 26 or an associated certificate server for validation. The client certificate 32 may then be installed on the client computer system 32, with the corresponding client private key 33 being generated at such time. In lieu of, or in addition to the foregoing out-of-band authentication, the user may be presented with an additional knowledge-based authentication. For example, the user may be asked about their favorite color, the high school they attended, and other similar questions. It is understood that the foregoing procedure “registers” the browser on the client computer system 12 with the authentication server 26, effectively making such browser an authentication factor (“Something the user has”).

With reference again to FIG. 3, according to another aspect of the present invention, the client computer system 12 includes a client authentication module 92. The client authentication module 92 is understood to handle the processes on the client side as discussed above. In this regard, it is to be understood that references to the client computer system 12, especially in the context of the client computer system 12 performing certain functionalities in accordance with the various embodiments of the present invention, are understood to refer to the client authentication module 92. In one embodiment, the client authentication module 92 is an Active-X component or other browser-based extension that is installed with a single user interaction via the web browser application 13 on the client computer system 12. However, alternative executable components that may be added on to the browser, including JAVA applets and the like, are also deemed to be within the scope of the present invention.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention with more particularity than is necessary for the fundamental understanding of the present invention, the description taken with the drawings making apparent to those skilled in the art how the several forms of the present invention may be embodied in practice.

What is claimed is:

1. A method for authenticating a client and a server, the client having a client certificate and the server having a server certificate, the method comprising:
validating the client to an authentication module based upon a certificate request identifier generated thereby, a secure data link certificate, and an authentication module uniform resource locator (URL);
validating the authentication module to the client based upon the client certificate and the certificate request identifier;
transmitting a user identifier and an associated password to the authentication module, the password being encrypted with a private client key of the client certificate and signed with a public server key of the server certificate; and
validating the password for the client to access the server.

2. A method for bi-directionally authenticating a client and a server, the method comprising:
validating the client and an authentication module over a secure communications link, a server certificate and a certificate request identifier signed by a server private key being received by the client;
receiving a password request, the server certificate, and the certificate request identifier signed with the server private key, the password request being associated with a user identifier;
transmitting a password responsive to the password request, the password being encrypted with a server public key and signed with a client private key; and
receiving a server validation message upon validation of the user identifier and the password.

3. The method of claim 2, wherein the user identifier and the password are independent of the authentication module.

4. The method of claim 2, wherein the secure communications link is Transport Security Layer/Secure Sockets Layer (TLS/SSL) compliant.

5. The method of claim 2, wherein the client certificate and the server certificate are X.509 compliant.

6. The method of claim 2, wherein the client is a web browser application including a key store, the client certificate, the client private key, and the server public key being stored therein.

7. The method of claim 2, further comprising:
transmitting a user identifier to the authentication module.

8. The method of claim 2, further comprising:
validating the password request with the server certificate and the certificate request identifier.

9. The method of claim 2, wherein the step of validating the client and the authentication module includes:
receiving a first request to access the server from the client;
transmitting the certificate request identifier and the server certificate to the client in response to the first request, the certificate request identifier uniquely corresponding to the first request and being signed by the server private key;
establishing the secure data transfer link between the client and the authentication module, a secure data link certificate and a locator address associated with the authentication module being transmitted to the client during the establishment of the secure data transfer link;
transmitting to the authentication module a credential packet including the client certificate, the certificate request identifier, the locator address, the secure data link certificate, and an authenticity identifier of the credential packet, the credential packet being signed with the server public key; and
validating the credential packet.

10. The method of claim 9, wherein the authenticity identifier is a cryptographic hash.

11. The method of claim 9, wherein validating the credential packet further includes validating the certificate request identifier stored therein against the certificate request identifier initially transmitted to the client.

12. The method of claim 9, wherein validating the credential packet further includes validating the secure data link certificate stored therein against the secure data link certificate on the authentication module.

13. The method of claim 9, wherein validating the credential packet further includes validating the locator address stored therein against an address of the authentication module.

14. The method of claim 9, wherein validating the credential packet further includes validating the client certificate against the client public key retained by the authentication module.

15. A method for bi-directionally authenticating a client and a server, the method comprising:
validating the client and an authentication module over a secure communications link, a server certificate and a certificate request identifier signed by a server private key being transmitted to the client;
transmitting a password request, the server certificate, and the certificate request identifier signed with the server private key, the password request being associated with a user identifier;
receiving a password responsive to the password request, the password being encrypted with a server public key and signed with a client private key; and
transmitting a server validation message upon confirmation of the user identifier and the password.

16. The method of claim 15, wherein the user identifier and the password are independent of the authentication module.

17. The method of claim 15, wherein the secure communications link is Transport Security Layer/Secure Sockets Layer (TLS/SSL) compliant.

18. The method of claim 14, wherein the client certificate and the server certificate are X.509 compliant.

19. The method of claim 15, further comprising:
receiving a user identifier from the client.

20. The method of claim 15, further comprising:
validating the password request with the server certificate and the certificate request identifier.

21. The method of claim 15, wherein the step of validating the client and the authentication module includes:
receiving a first request to access the server;
transmitting the certificate request identifier and the server certificate to the client in response to the first request, the certificate request identifier uniquely corresponding to the first request and being signed by the server private key;
establishing the secure data transfer link between the client and the authentication module, a secure data link certificate and a locator address associated with the authentication module being transmitted to the client during the establishment of the secure data transfer link;
receiving a credential packet including the client certificate, the certificate request identifier, the locator address, the secure data link certificate, and an authenticity identifier of the credential packet, the credential packet being signed with the server public key; and
validating the credential packet.

22. The method of claim 21, wherein the authenticity identifier is a cryptographic hash.

23. The method of claim 21, wherein validating the credential packet further includes validating the certificate request identifier stored therein against the certificate request identifier initially transmitted to the client.

24. The method of claim 21, wherein validating the credential packet further includes validating the secure data link certificate stored therein against the secure data link certificate on the authentication module.

25. The method of claim 21, wherein validating the credential packet further includes validating the locator address stored therein against an address of the authentication module.

26. The method of claim 21, wherein validating the credential packet further includes validating the client certificate against the client public key retained by the authentication module.

27. A method for bi-directionally authenticating a client and a server, the client having a client certificate, a corresponding client private key, and a server public key, and the server having a server certificate, a corresponding server private key, and a client public key, the method comprising:
receiving a first request to access the server from the client;
transmitting a certificate request identifier and the server certificate to the client in response to the first request, the certificate request identifier uniquely corresponding to the first request and being signed by the server private key;
establishing a secure data transfer link between the client and an authentication module, a secure data link certificate and a locator address associated with the authentication module being transmitted to the client during the establishment of the secure data transfer link;
transmitting to the authentication module a credential packet including the client certificate, the certificate request identifier, the locator address, the secure data link certificate, and an authenticity identifier of the credential packet, the credential packet being signed with the server public key;
validating the credential packet;
transmitting to the client a password request, the server certificate, and the certificate request identifier signed with the server private key;
transmitting to the authentication module a password responsive to the password request, the password being encrypted with the server public key and signed with the client private key; and
transmitting to the client a server validation message upon avalidation of the password.

28. The method of claim 1, wherein after receiving the first request to access the server, the client is redirected to the authentication module, the certificate request identifier and the server certificate being transmitted therefrom.
